(19) United States
(12) Patent Application Publication
(10) Pub. No.: US 2015/0083872 A1
(43) Pub. Date: Mar. 26, 2015

(54) SEAT MOUNTING STRUCTURE

(71) Applicants: TS TECH CO., LTD., Asaka-shi, Saitama (JP); HONDA MOTOR CO., LTD., Tokyo (JP)

(72) Inventors: Teppei Ito, Shioya-gun (JP); Kazuyuki Kaneko, Wako-shi (JP)

(21) Appl. No.: 14/383,673

(22) PCT Filed: Mar. 8, 2013
(86) PCT No.: PCT/JP2013/056425

§ 371 Date: Sep. 8, 2014

(30) Foreign Application Priority Data
Mar. 9, 2012 (JP) 2012-053232

(51) Int. Cl. B60N 2/015

(52) U.S. Cl. CPC B60N 2/015
USPC 248/205.1

(57) ABSTRACT

Provided is a seat mounting structure which enables stable mounting of a seat frame. A seat mounting structure is provided with right and left support members which support a seat frame of a seat within the floor of a vehicle, and a coupling member which is hung between the right and left support members and couples the support members. At least one of the right and left support members is provided with a base part, a sidewall part which extends upward from the base part and to which the seat frame and the coupling member are mounted, and first and second mounting parts for securing the base part to the floor. A coupling section to which the coupling member is coupled in the sidewall part is disposed within a space created by projecting a region formed by connecting the first and second mounting parts upward.

### TECHNICAL FIELD

The present invention relates to a seat mounting structure.

### BACKGROUND ART

Some conventional vehicles are provided with stowable rear seats so that the rear seat space can be expanded when there is no passenger on the rear seats. The seat frames of such seats are supported by right and left support members that are mounted on the floor (for example, see Patent Document 1).

### PRIOR ART DOCUMENT

### Patent Document

Patent Document 1: JP 2010-100229A

### SUMMARY OF INVENTION

### Problem to be Solved by the Invention

There has been a demand for stably mounting a seat frame on a floor.

Accordingly, it is an object of the present invention to provide a seat mounting structure that can stably mount a seat frame.

### Means for Solving the Problem

In order to solve the above problems, the invention described in claim 1 is a seat mounting structure, including:

right and left support members which support a seat frame of a seat within a floor of a vehicle; and

a coupling member which is hung between the right and left support members to couple the support members with each other,

wherein at least one of the right and left support members comprises:
a base part;
a sidewall part which extends upward from the base part, and to which the seat frame and the coupling member are attached; and
a first mounting part and a second mounting part which fix the base part on the floor, and

wherein a coupling section of the sidewall part to which the coupling member is coupled is disposed in a space created by upwardly projecting a region connecting the first mounting part and the second mounting part.

The invention described in claim 2 is the seat mounting structure according to claim 1,

wherein the sidewall part comprises a protrusion which protrudes to at least one of right and left, and the coupling section is provided at a tip of the protrusion, so that the coupling section is disposed in the space.

The invention described in claim 3 is the seat mounting structure according to claim 1,

wherein the sidewall part protrudes toward the inside of the vehicle so that the coupling section is disposed in the space.

The invention described in claim 4 is the seat mounting structure according to any one of claims 1 to 3,

wherein a lower end of the sidewall part protrudes with respect to an upper end of the sidewall part so that the coupling section is disposed in the space.

The invention described in claim 5 is the seat mounting structure according to any one of claims 1 to 4,

wherein the sidewall part comprises a rolling shaft attaching part on which a rolling shaft of the seat frame is mounted, and

wherein the rolling shaft attaching part as well as the coupling section is disposed in the space.

The invention described in claim 6 is the seat mounting structure according to claim 4 or 5,

wherein an engaging member with which a lower end of the seat frame is engaged is disposed at an upper end of the sidewall part,

wherein the sidewall part comprises a rolling shaft attaching part on which a rolling shaft of the seat frame is attached, and

wherein a part of the sidewall part below the rolling shaft attaching part protrudes with respect to the rolling shaft attaching part so that the coupling section is disposed in the space.

The invention described in claim 7 is the seat mounting structure according to any one of claims 1 to 6,

wherein the coupling section is disposed on a virtual plane connecting centers of the first mounting part and the second mounting part.

The invention described in claim 8 is the seat mounting structure according to any one of claims 1 to 7,

wherein the first mounting part is disposed at a front side of the coupling section, and the second mounting part is disposed at a rear side of the coupling section,

wherein a center of the first mounting part is located at an outer side with respect to the coupling section, and

wherein a center of the second mounting part is located at an inner side with respect to the coupling section.

The invention described in claim 9 is the seat mounting structure according to claim 8,

wherein a most inwardly protruding part of a wheel house in the vehicle is opposed to the second mounting part at an inner side of the most inwardly protruding part in a right-left direction.

The invention described in claim 10 is the seat mounting structure according to claim 8 or 9,

wherein the support member is disposed along a wheel house in the vehicle.

The invention described in claim 11 is the seat mounting structure according to any one of claims 8 to 10,

wherein at least a part of a wheel house in the vehicle comprises a suspension house that protrudes inward to house a suspension, and

wherein the suspension house is opposed to the second mounting part.

The invention described in claim 12 is the seat mounting structure according to claim 11,

wherein the suspension house is a most inwardly protruding part of the wheel house in the vehicle, and

wherein the first mounting part is disposed in an area at a front side of a front step of the suspension house.

The invention described in claim 13 is the seat mounting structure according to claims 12,

wherein the coupling section is disposed opposite to the front step.

### Effects of Invention

According to the invention described in claim 1, the coupling member is disposed in a space that is created by upwardly projecting a region formed by connecting the first and the second mounting parts. Accordingly, the weight of the coupling member acts on the support member via the coupling section in an approximately vertical direction. If the coupling section is disposed outside the space, the weight of the coupling member acts on the support member in a diagonal direction, which may make the support members unstable. In contrast, disposing the coupling section in the space can stabilize the mounting strength of the support member.

According to claim 2, the sidewall part protrudes to either the right or the left so that the coupling section is disposed in the space. This protrusion can enhance the rigidity of the support member.

According to the invention described in claim 3, the sidewall part is formed such that the coupling section protrudes toward the inside of the vehicle. This can conserve the space in the width direction of the vehicle.

According to the invention described in claim 4, the lower end of the sidewall part protrudes with respect to the upper end of the sidewall part. This can further enhance the rigidity of the support member.

According to the invention described in claim 5, the rolling shaft attaching part and the coupling section are disposed in the space. This can allow a force acting on the rolling shaft attaching part to act on the support member in an approximately vertical direction. As a result, this can further stabilize the mounting strength of the support member.

According to the invention described in claim 6, the engaging member with which the lower end of the seat frame is engaged is disposed at the upper end of the sidewall part. That is, the engaging member is disposed at the upper end, which forms a step with respect to the lower end of the sidewall part. This can prevent an increase in size.

Further, the part of the sidewall part below the rolling shaft attaching part protrudes with respect to the rolling shaft attaching part. This can further enhance the rigidity of the support member even when the rolling shaft attaching part is provided.

According to the invention described in claim 7, the coupling section is disposed on the virtual plane connecting the centers of the first and second mounting parts. This allows the weight of the coupling member to act on the support member in the vertical direction. As a result, this can further stabilize the mounting strength of the support member.

According to the invention described in claim 8, the center of the first mounting part is located at the outer side with respect to the coupling section, and the center of the second mounting part is located at the inner side with respect to the coupling section. Accordingly, the region connecting the first and second mounting parts is diagonal to the extending direction of the coupling member. This inclination of the region with respect to the extending direction of the coupling member makes the structure robust against forces in both the fore-aft direction and the right-left direction.

According to the invention described in claim 9, the most inwardly protruding part of the wheel house is opposed to the second mounting part. That is, the most inwardly protruding part of the wheel house is disposed at the outer side of the second mounting part that is located at the inner side with respect to the first mounting part. This can make efficient use of the installation space.

According to the invention described in claim 10, the support member is disposed along the wheel house in the vehicle. This can make efficient use of the area narrowed inwardly by the wheel house for mounting the support member. Further, in case the support member 4 is about to be deformed outward, the wheel house can support the support member from the outer side, and thus can prevent the support member from falling down.

According to the invention described in claim 11, the suspension house and the second mounting part are opposed to each other. This can make efficient use of the installation space even when the suspension house is provided in the wheel house.

According to the invention described in claim 12, the first mounting part is disposed in the area at the front side of the front step of the suspension house, which is the most inwardly protruding part of the wheel house. This can make efficient use of the installation space.

According to the invention described in claim 13, the coupling section is disposed opposite to the front step. This allows the coupling section to be close to the front step, and can thus make efficient use of the installation space.

### BRIEF DESCRIPTION OF DRAWINGS

FIG. 1 This is a perspective view of a rear seat according to an embodiment of the present invention, illustrating the schematic configuration thereof.

FIG. 2 This is a top view of a rear seat mounting structure according an embodiment of the present invention, illustrating the schematic configuration thereof.

FIG. 3 This is a perspective view of a support member according to an embodiment of the present invention, illustrating the schematic configuration thereof.

FIG. 4 This is a front view of the support member in FIG. 3.

FIG. 5 This is a top view of a space where a coupling section according to an embodiment of the present invention is disposed.

FIG. 6A This is a top view of support members according to a first variation, illustrating the schematic configuration thereof.

FIG. 6B This is a perspective view of the support members according to the first variation, illustrating the schematic configuration thereof.

FIG. 7 This is a top view of a space where a coupling section of the first variation is disposed.

FIG. 8A This is a top view of support members according to a second variation, illustrating the schematic configuration thereof.

FIG. 8B This is a perspective view of the support members according to the second variation, illustrating the schematic configuration thereof.

FIG. 9A This is a top view of support members according to a third variation, illustrating the schematic configuration thereof.

FIG. 9B This is a perspective view of the support members according to the third variation, illustrating the schematic configuration thereof.

FIG. 10 This is a top view of support members according to a fourth variation, illustrating the schematic configuration thereof.

### DESCRIPTION OF EMBODIMENTS

Hereinafter, an embodiment of the present invention will be described with the drawings. While the following embodiment includes a variety of limitations that are technically preferable for embodying the present invention, the scope of the present invention is not limited to the following embodiment or the illustrated examples.

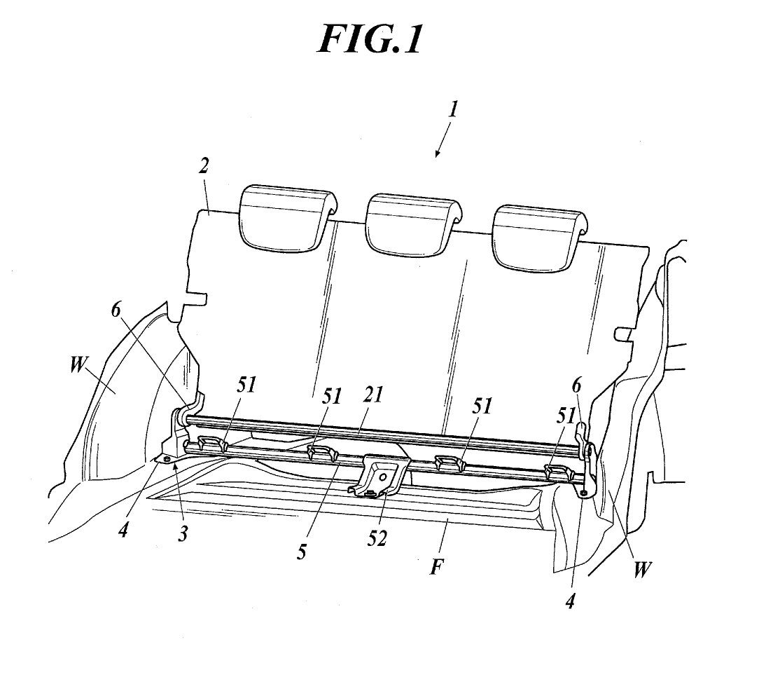

FIG. 1 is a perspective view of a rear seat according to the embodiment of the present invention, illustrating the schematic configuration thereof. As illustrated in FIG. 1, a rear seat 1 is provided with a seat frame 2 that is covered with a seat pad (not shown) and is disposed in a reclinable manner in the fore-aft direction. At the right and left lower ends of the seat frame 2, a seat mounting structure 3 according to the present invention is applied. With this structure, the seat frame 2 can be reclined/raised in the fore-aft direction.

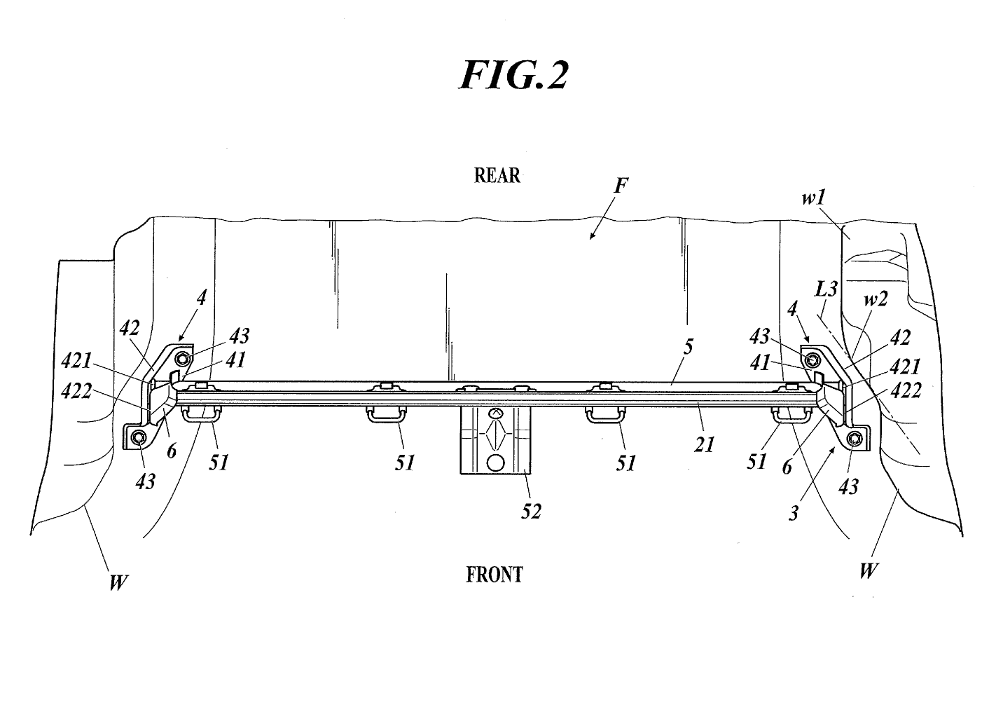

Hereinafter, the seat mounting structure 3 according to the present invention will be described in more detail. FIG. 2 is a top view of the seat mounting structure 3, illustrating the schematic configuration thereof. As illustrated in FIG. 1 and FIG. 2, the seat mounting structure 3 includes a pair of right and left support members 4 that support the seat frame 2 in a floor of a vehicle, a coupling member 5 that is hung between the pair of left and right support members 4 to couple the pair of support members 4 with each other, and engaging members 6 to engage the right and left lower ends of the seat frame 2 respectively with the pair of support members 4.

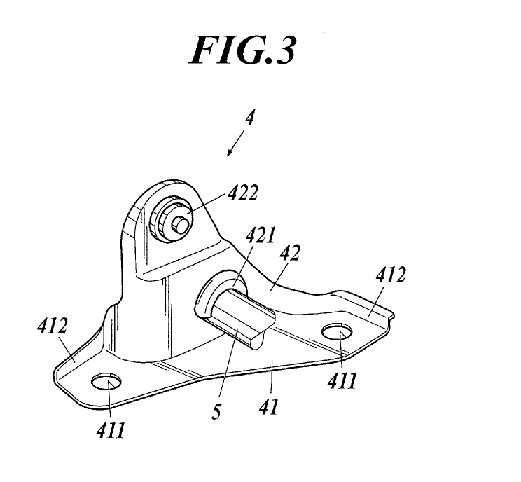

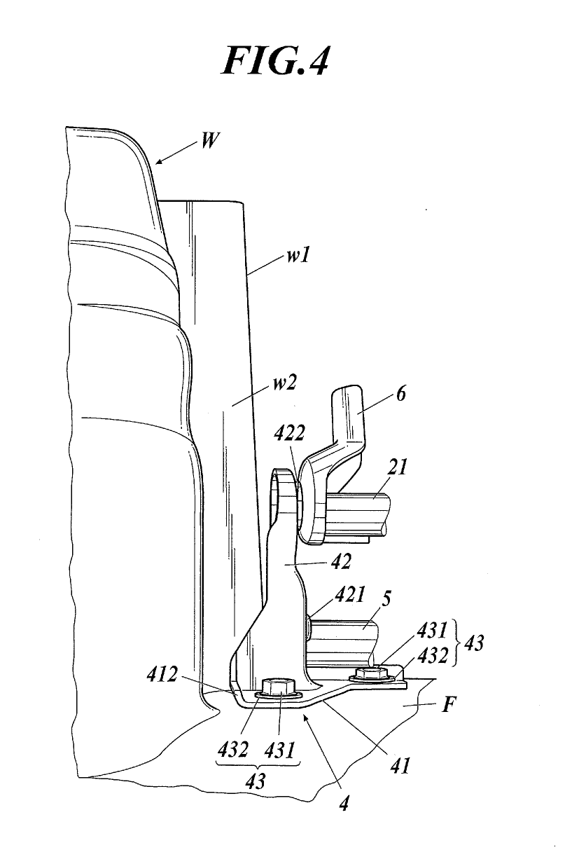

FIG. 3 is a perspective view of the support member 4, illustrating the schematic configuration thereof, and FIG. 4 is a front view of the support member 4. As illustrated in FIG. 2 through FIG. 4, each of the support members 4 includes a base part 41 that is mounted on the floor surface of a floor F, a sidewall part 42 that extends upward from the base part 41, and a pair of fixing parts 43 that fix the base part 41 on the floor surface of the floor F.

The base part 41 extends in the fore-aft direction such that the front end is disposed at an outer side and the rear end is disposed at an inner side. At the front end and the rear end of the base part 41, a pair of fixing holes 411 is formed, to which the fixing parts 43 are attached.

The fixing parts 43 include bolts 431 and washers 432. By inserting the bolts 431 in the washers 432 and fixing holes 411, and screwing them into tapped holes (not shown) of the floor F, the base part 41 is affixed to the floor F by the fixing parts 43. The fixing part 43 attached at the front part of the base part 41 corresponds to a first mounting part of the present invention, and the fixing part 43 attached at the rear part of the base part 41 corresponds to a second mounting part of the present invention.

The sidewall part 42 extends upward from the outer part of the edge of the base part 41, and the lower end thereof protrudes toward the inside of the vehicle with respect to the upper end thereof. This protrusion of the sidewall part 42 serves as a coupling section 421 where the coupling member 5 is attached. Accordingly, the pair of fixing parts 43 is positioned so as to sandwich the coupling section 421 in the fore-aft direction. Further, the center of the front fixing part 43 is located at the outer side with respect to the coupling section 421, and the center of the rear fixing part 43 is located at the inner side with respect to the coupling section 421.

On the upper end of the sidewall part 42, a rolling shaft attaching part 422 is provided, where a rolling shaft 21 of the seat frame 2 is attached via an engaging member 6.

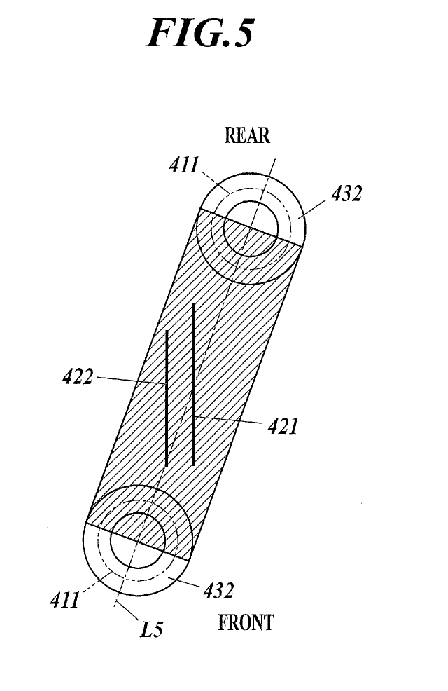

The coupling section 421 and the rolling shaft attaching part 422 are disposed in a space S, which is created by upwardly projecting the region connecting the pair of fixing parts 43. Specifically, as illustrated in FIG. 5, the space S is a space that is created by upwardly projecting the region formed by connecting the inner and outer ends of one washer 432 of the pair of fixing parts 43 respectively with the inner and outer ends of the other washer 432 (see the hatched area in FIG. 5). It is required that at least a part of the coupling section 421 and at least a part of the rolling shaft attaching part 422 are disposed in the space S. However, it is preferred that the whole coupling section 421 and the whole rolling shaft attaching part 422 are disposed in the space S. As illustrated in FIG. 5, it is also preferred that the positioning of the rolling shaft attaching part 422 and the coupling section 421 intersects with a virtual plane L5 connecting the centers of the pair of fixing parts 43 in the space S.

Further, at the front end and the rear end of the base part 41, ribs 412 that continue to the sidewall part 42 are formed. These ribs 412 enhance the rigidity of the whole support member 4. In terms of enhancing the rigidity, it is preferred that the ribs 412 are formed not only at the front end and the rear end of the base part 41 but also extend continuously to the protruded lower end of the sidewall part 42.

As described above, the base part 41 is disposed such that the front end is located at the outer side and the rear end is located at the inner side, and the sidewall part 42 protrudes inward at the center part. Accordingly, each support member 4 can be disposed around a wheel house W of the vehicle along the front end of the wheel house W of the vehicle. To be more specific, as illustrated in FIG. 2, at least a part of the wheel house W is a suspension house w1 that protrudes inward to house a suspension. In addition to the suspension house w1, the wheel house W may also include a fuel pipe house that houses a fuel pipe, etc.

The suspension house w1 is the part of the wheel house W that protrudes the most. The suspension house w1 and the rear fixing part 43 are disposed opposite to each other at the inner side in the right-left direction of this most protruded part. Further, the front fixing part 43 is disposed in an area at the front side of a front step w2 of the suspension house w1. Accordingly, the support member 4 is disposed along the extension line L3 of the wall of the front step w2. With this arrangement of the support member 4 along the wheel house W, the area narrowed inward by the wheel house W can be effectively used for mounting the support member 4. Further, in case the support member 4 is about to be deformed outward, the wheel house W can support the support member 4 from the outer side, and thus can prevent the support member 4 from falling down.

Further, since the coupling section 421 is disposed opposite to the front step w2, the coupling section 421 can be disposed close to the front step w2. This can make efficient use of the installation space.

The coupling member 5 is a bar member that extends in the right-left direction as illustrated in FIG. 1 and FIG. 2. At predetermined positions of the coupling member 5, locking members 51 for mounting a child seat or the like are fixed. Further, at the center part of the coupling member 5, a fixture 52 that fixes the coupling member 5 on the floor F is attached.

As described above, according to the embodiment of the present invention, each coupling section 421 is disposed in the space S, which is created by upwardly projecting the region connecting the pair of fixing parts 43. Accordingly, the weight of the coupling member 5 acts on the support members 4 in an approximately vertical direction via the coupling sections 421. If each coupling section 421 is located outside the space S, the weight of the coupling member 5 acts diagonally on the support members 4, which may make the support members 4 unstable. In contrast, disposing each coupling section 421 in the space S can stabilize the mounting strength of the support members 4.

Further, each sidewall part 42 is configured such that the lower end protrudes with respect to the upper end. This can enhance the rigidity of the support members 4.

Further, each engaging member 6 is disposed at the upper end of the sidewall part 42. That is, each engaging member 6 is disposed at the upper end of the sidewall part 42 that forms a step with respect to the lower end. This can prevent an increase in size.

Further, the part below the rolling shaft attaching part 422 of each sidewall part 42 protrudes with respect to the rolling shaft attaching part 422. This can enhance the rigidity of the support members 4 even when the rolling shaft attaching parts 422 are provided.

Further, in addition to the coupling section 422, each rolling shaft attaching part 42 is disposed in the space S. This allows a force acting on the rolling shaft attaching part 42 to also act on the support member 4 in an approximately vertical direction. This can further stabilize the mounting strength of the support members 4.

Further, the center of each front fixing part 43 is located at the outer side with respect to the coupling section 422, and the center of each rear fixing part 43 is located at the inner side with respect to the coupling section 422. Accordingly, the region connecting the pair of fixing parts 43 is diagonal to the extending direction of the coupling member 5. If the region connecting the pair of fixing parts is parallel to the extending direction of the coupling member 5, the structure is vulnerable to a force in the fore-aft direction. If the region is orthogonal to the extending direction of the coupling member 5, the structure is vulnerable to a force in the right-left direction. In contrast, since the region is diagonal to the extending direction of the coupling member 5, the structure is robust against forces in both fore-aft direction and right-left direction.

Further, each rear fixing part 43 is opposed to the most inwardly protruding part of the wheel house W (e.g. suspension house w1). Accordingly, the most inwardly protruding part is located at the outer side of the rear fixing part 43 that is located at the inner side with respect to the front fixing part 43. This can make efficient use of the installation space.

Further, each front fixing part 43 is disposed in the area at the front side of the front step w2 of the suspension house w1, which is the most inwardly protruding part of the wheel house W. This can make efficient use of the installation space.

Further, since each coupling section 422 is disposed opposite to the front step w2, the coupling section 422 can be disposed close to the front step w2. This can make efficient use of the installation space.

The seat mounting structure can be fixed on the floor F after the support members 4, the coupling member 5, the engaging members 6 and the rolling shaft 21 are assembled to the seat frame 2. This eliminates the need for a horizontal tightening operation in the vehicle. As a result, the workability of assembly can be improved in comparison to a procedure whereby only the support members 4 are initially fixed to the floor F, after which other parts are assembled thereto.

The embodiments to which the present invention is applicable are not limited to the above-described embodiment, and may be suitably changed without departing from the present invention. In the following description, the portions that are similar to those of the above-described embodiment are referred to by the same reference signs, and the descriptions thereof are omitted.

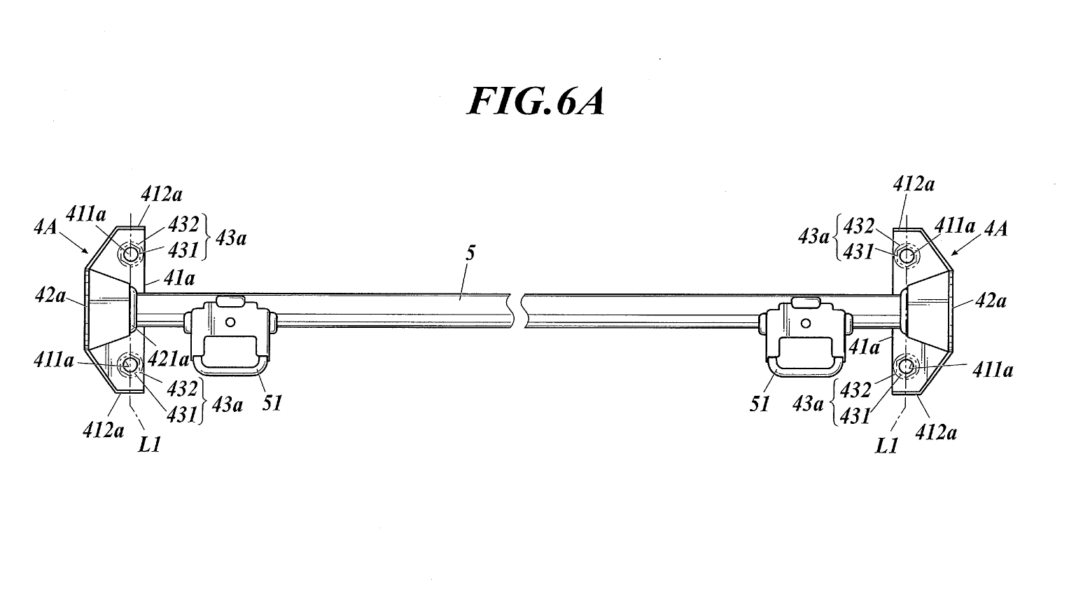

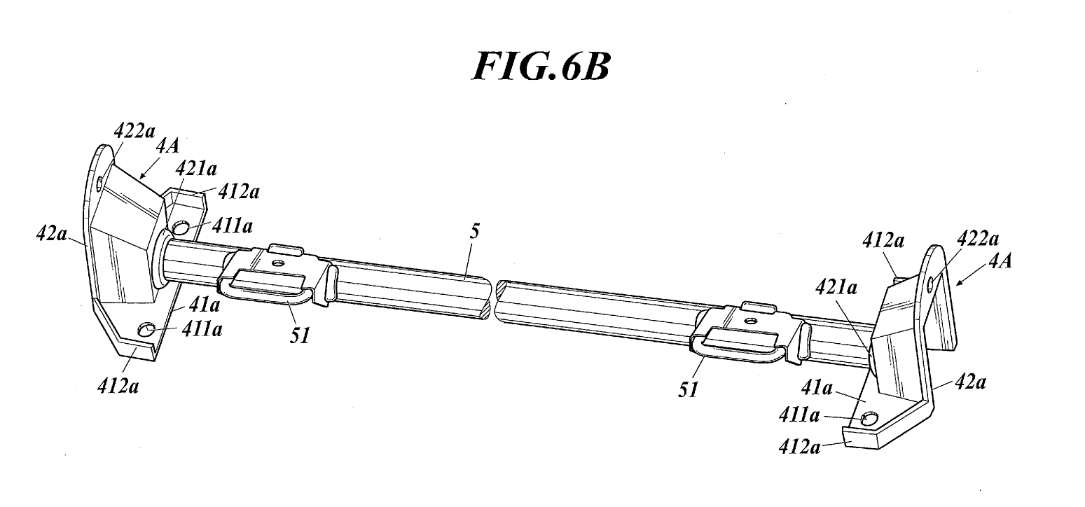

FIG. 6A is a top view of support members according to a first variation, illustrating the schematic configuration thereof, and FIG. 6B is a perspective view of the support members according to the first variation, illustrating the schematic configuration thereof.

Each of the support members 4A illustrated in FIG. 6A and FIG. 6B includes a base part 41a that is disposed on the floor surface of a floor F, a sidewall part 42a that extends upward from the base part 41a, and a pair of fixing parts 43a that fix the base part 41a on the floor surface of the floor F.

The base part 41a extends in the fore-aft direction. At the front end and the rear end thereof, a pair of fixing holes 411a where the fixing parts 43a are attached is formed. The pair of fixing holes 411a is disposed on a line L1 that is parallel to the fore-aft direction.

The fixing parts 43a include bolts 431 and washers 432. By inserting the bolts 431 in the washers 432 and the fixing holes 411 and screwing them into tapped holes (not shown) of the floor F, the base part 41 is fixed to the floor F by the fixing parts 43a. Since the fixing parts 43a are fixed on the floor F through the pair of fixing holes 411, the pair of fixing parts 43a attached on the base part 41a is also disposed on the line L1.

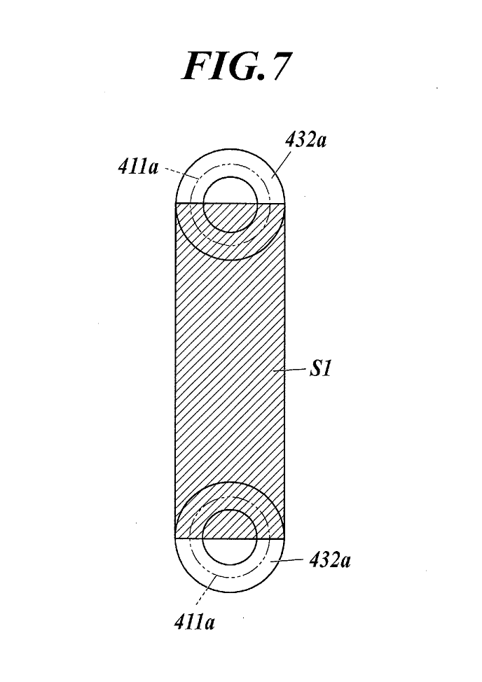

The sidewall part 42a extends upward from the outer part of the edge of the base part 41a, and the center part thereof protrudes toward the inside of the vehicle. The tip of the center part (protrusion) of the sidewall part 42a is a coupling section 421a to which a coupling member 5 is attached. The coupling section 421a is disposed in a space S1, which is created by upwardly projecting the region connecting the pair of fixing parts 43. Specifically, as illustrated in FIG. 7, the space S1 is a space that is created by upwardly projecting the region formed by connecting the inner and outer ends of one washer 432 of the pair of fixing parts 43a to the inner and outer ends of the other washer 432, respectively (see the hatched area in FIG. 7). That is, in the space S1, the coupling section 421a may not be disposed on a line L1 parallel to the fore-aft direction as illustrated in FIG. 6A and FIG. 6B, but may be disposed diagonal to the line L1.

On the upper end of the sidewall part 42a, a rolling shaft hole 422a is formed, to which a rolling shaft 21 of the seat frame 2 is attached via an engaging member 6.

Further, at the front end and the rear end of the base part 41a, ribs 412a that continue to the sidewall part 42a are formed. These ribs 412a enhance the rigidity of the whole support member 4A.

Also in the first variation, each coupling section 421a is disposed in the space S1, which is created by upwardly projecting the region connecting the pair of fixing part 43. Accordingly, the weight of the coupling member 5 acts on the support members 4A in an approximately vertical direction via the coupling sections 421a. If each coupling section 421a is located outside the space S1, the weight of the coupling member 5 acts diagonally on the support members 4A, which may make the support members 4A unstable. In contrast, disposing each coupling section 421a in the space S1 enables stabilization of the mounting strength of the support members 4A.

Further, each sidewall part 42a protrudes to either the right or the left so that the coupling section 421a is disposed in the space S1. This protruded part of each sidewall part 42a can enhance the rigidity of the support members 4A.

Further, each sidewall part 42a is formed such that the coupling section 421a protrudes toward the inside of the vehicle. This can conserve the space in the direction of the vehicle width.

In the first variation, each sidewall part 42a is formed such that the coupling section 421a protrudes toward the inside of the vehicle. However, each sidewall part may be formed such that the coupling section protrudes toward the outside of the vehicle.

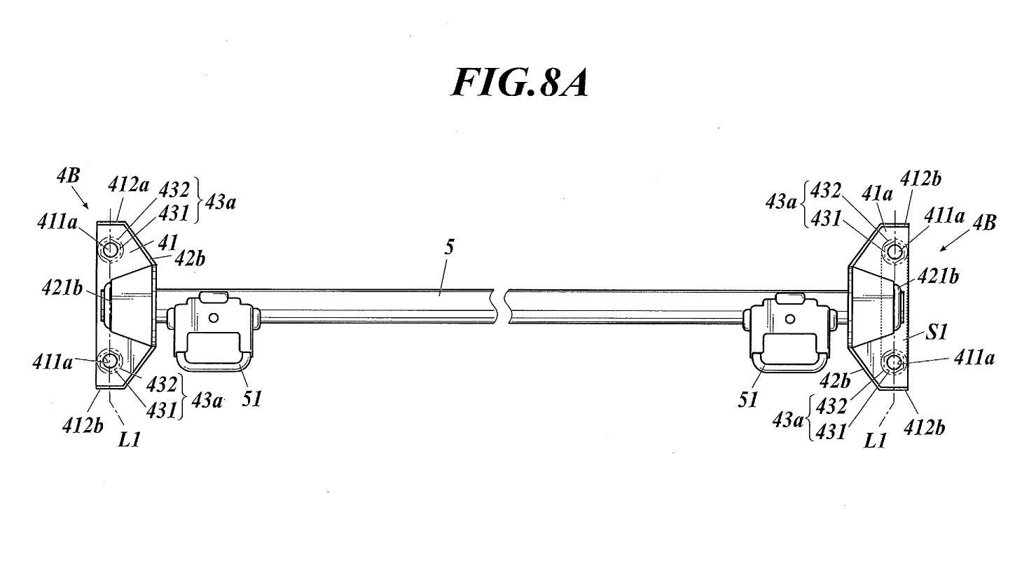

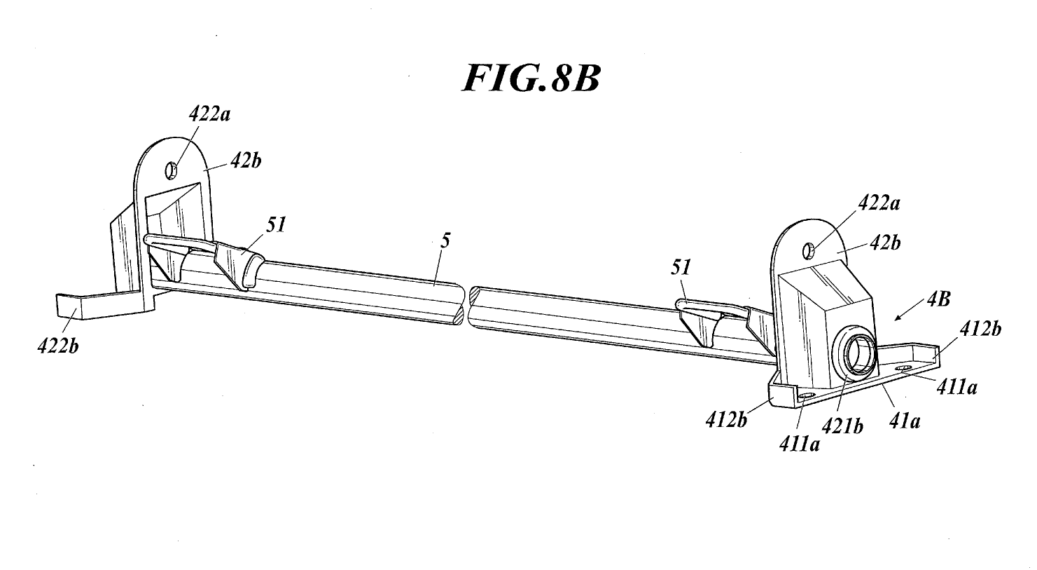

FIG. 8A is a top view of support members 4B according to a second variation, illustrating the schematic configuration thereof, and FIG. 8B is a perspective view of the support members 4B, illustrating the schematic configuration thereof.

Each of the support members 4B includes a base part 41a that is mounted on the floor surface of a floor F, a sidewall part 42b that extends upward from the base part 41a, and a pair of fixing parts 43a that fix the base part 41b on the floor surface of the floor F.

The sidewall part 42b extends upward from the inner part of the edge of the base part 41a, and the center part thereof protrudes toward the outside of the vehicle. The center part of the sidewall part 42b is hollow, and a coupling member 5 is attached on the inner side. That is, the center part of the sidewall part 42b is a coupling section 421b to which the coupling member 5 is attached. The coupling section 421b is disposed in a space S1, which is created by upwardly projecting the region connecting the pair of the fixing parts 43a.

Further, at the front end and the rear end of the base part 41a, ribs 412b that continue to the sidewall part 42b are formed. The ribs 412b enhance the rigidity of the whole support member 4B.

As described above, the sidewall part 42b is formed such that the coupling section 421b protrudes toward the outside of the vehicle. This can further stabilize the coupling member 5 by supporting the coupling member 5 with a broader area.

In the first and second variations, each sidewall part 42a or 42b is formed such that the coupling section 421a or 421b protrudes. However, the sidewall part may not include a protrusion.

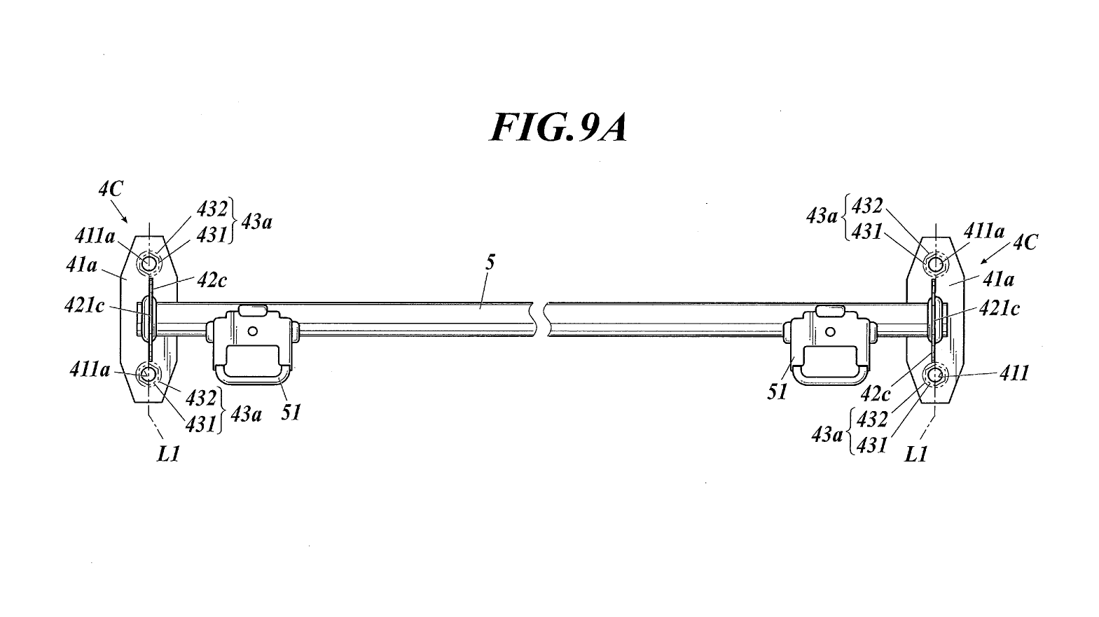

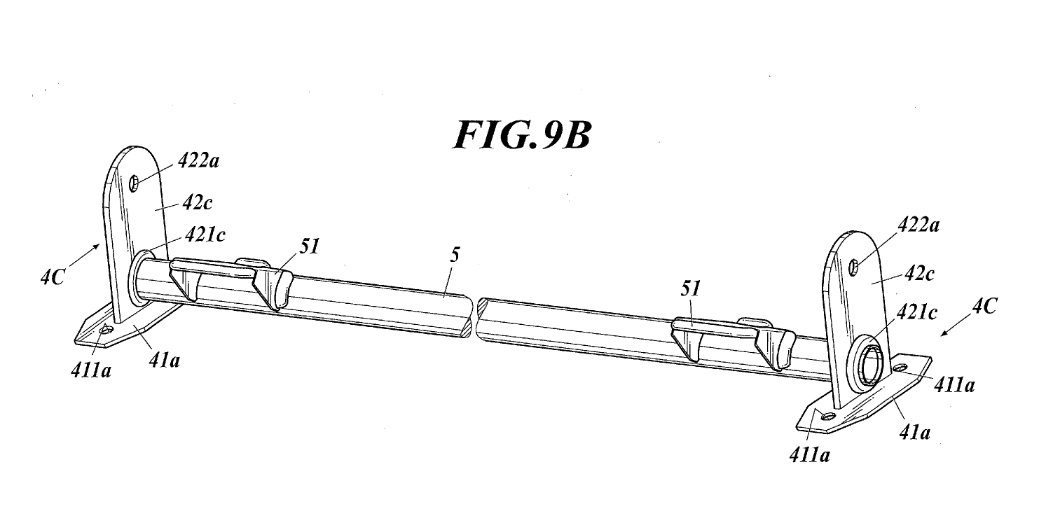

FIG. 9A is a top view of support members 4C according to a third variation, illustrating the schematic configuration thereof, and FIG. 9B is a perspective view of the support members 4C, illustrating the schematic configuration thereof.

Each of the support members 4C includes a base part 41a that is mounted on the floor surface of the floor F, a sidewall part 42c that extends upward from the base part 41a, and a pair of fixing parts 43a that fixes the base part 41a on the floor surface of the floor F.

The sidewall part 42c extends upward from the center of the base part 41a along a line L1. At the center part of the sidewall part 42c, a coupling member 5 is attached. That is, the center part of the sidewall part 42c is a coupling section 421c to which the coupling member 5 is attached. The coupling section 421c is disposed on a virtual plane connecting the centers of the pair of fixing parts 43a (illustrated as the line L1 in FIG. 9A).

As described above, the coupling section 421c is disposed on the virtual plane L1 connecting the centers of the pair of fixing parts 43a. This allows the weight of the coupling member 5 to act on the support members 4C in the vertical direction. As a result, this can further stabilize the mounting strength of the support members 4C.

In each of the above-described embodiments, the pair of right and left support members 4, 4A, 4B or 4C has the same shape. However, the right and left support members may have different shapes from each other in conformity with the shape of the floor F of the vehicle.

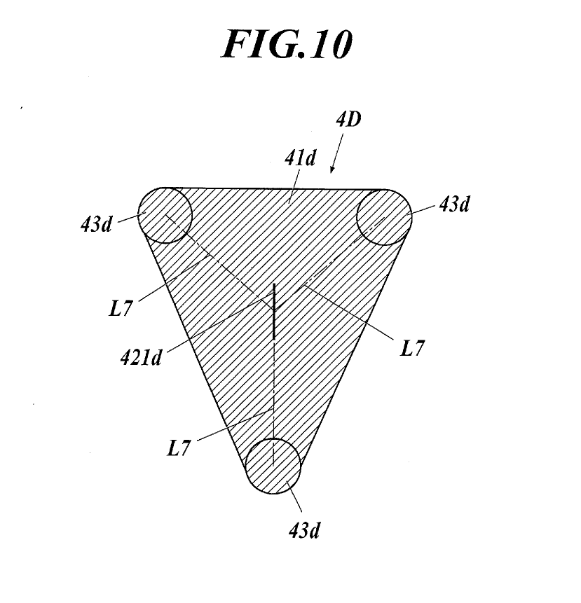

The above-described embodiments illustrate examples in which each support member 4 is provided with two fixing parts 43. However, each support member 4 may be provided with three of more fixing parts 43. FIG. 10 is a top view illustrating a space where a coupling section is disposed on a support member that includes three fixing parts. As illustrated in FIG. 10, a base part 41d of a support member 4D is configured such that the lines connecting fixing parts 43 form an approximately triangular shape in which the fixing parts 43d are provided at the respective corners. The coupling section 421d is disposed in a region surrounded by the fixing parts 43d (hatched area of FIG. 10). Further, it is preferred that the coupling section 421 is disposed at the point where straight lines L7 that pass through the centers of the fixing parts 43d intersect.

The above-described embodiments illustrate examples in which the rear seat 1 is employed as the seat. However, the seat mounting structure 3 of the present invention is also applicable to mid seats and front seats in addition to the rear seat 1.

The above-described embodiments illustrate examples in which the first mounting part and the second mounting part are fixed on the floor F by bolts. However, at least one of the first mounting part or the second mounting part may be fixed on the floor F by welding. Also in this case, it is preferred that the coupling section is disposed in a space that is created by upwardly projecting a region connecting the welded parts (first and second mounting parts) welded on the floor F.

### INDUSTRIAL APPLICABILITY

The seat mounting structure according to the present invention is applicable to seats installed in a vehicle.

### DESCRIPTION OF REFERENCE NUMERALS

1 rear seat
2 seat frame
3 mounting structure (seat mounting structure)
4 support member
5 coupling member
6 engaging member
21 rolling shaft
41 base part
42 sidewall part
43 fixing part (first and second mounting parts)
421 coupling section
422 rolling shaft attaching part
F floor
S space
W wheel house
w1 suspension house
w2 front step

1. A seat mounting structure, comprising:
right and left support members which support a seat frame of a seat within a floor of a vehicle; and
a coupling member which is hung between the right and left support members to couple the support members with each other,
wherein at least one of the right and left support members comprises:
a base part;
a sidewall part which extends upward from the base part, and to which the seat frame and the coupling member are attached; and
a first mounting part and a second mounting part which fix the base part on the floor, and
wherein a coupling section of the sidewall part to which the coupling member is coupled is disposed in a space created by upwardly projecting a region connecting the first mounting part and the second mounting part.

2. The seat mounting structure according to claim 1,
wherein the sidewall part comprises a protrusion which protrudes to at least one of right and left, and the coupling section is provided at a tip of the protrusion, so that the coupling section is disposed in the space.

3. The seat mounting structure according to claim 1,
wherein the sidewall part protrudes toward the inside of the vehicle so that the coupling section is disposed in the space.

4. The seat mounting structure according to claim 1,
wherein a lower end of the sidewall part protrudes with respect to an upper end of the sidewall part so that the coupling section is disposed in the space.

5. The seat mounting structure according to claim 1,
wherein the sidewall part comprises a rolling shaft attaching part on which a rolling shaft of the seat frame is mounted, and
wherein the rolling shaft attaching part as well as the coupling section is disposed in the space.

6. The seat mounting structure according to claim 4,
wherein an engaging member with which a lower end of the seat frame is engaged is disposed at an upper end of the sidewall part,
wherein the sidewall part comprises a rolling shaft attaching part on which a rolling shaft of the seat frame is attached, and
wherein a part of the sidewall part below the rolling shaft attaching part protrudes with respect to the rolling shaft attaching part so that the coupling section is disposed in the space.

7. The seat mounting structure according to claim 1,
wherein the coupling section is disposed on a virtual plane connecting centers of the first mounting part and the second mounting part.

8. The seat mounting structure according to claim 1,
wherein the first mounting part is disposed at a front side of the coupling section, and the second mounting part is disposed at a rear side of the coupling section,
wherein a center of the first mounting part is located at an outer side with respect to the coupling section, and
wherein a center of the second mounting part is located at an inner side with respect to the coupling section.

9. The seat mounting structure according to claim 8,
wherein a most inwardly protruding part of a wheel house in the vehicle is opposed to the second mounting part at an inner side of the most inwardly protruding part in a right-left direction.

10. The seat mounting structure according to claim 8,
wherein the support member is disposed along a wheel house in the vehicle.

11. The seat mounting structure according to claim 8,
wherein at least a part of a wheel house in the vehicle comprises a suspension house that protrudes inward to house a suspension, and
wherein the suspension house is opposed to the second mounting part.

12. The seat mounting structure according to claim 11,
wherein the suspension house is a most inwardly protruding part of the wheel house in the vehicle, and
wherein the first mounting part is disposed in an area at a front side of a front step of the suspension house.

13. The seat mounting structure according to claim 12,
wherein the coupling section is disposed opposite to the front step.
